(19) United States
(12) Patent Application Publication
(10) Pub. No.: US 2010/0207343 A1
(43) Pub. Date: Aug. 19, 2010

(54) SUSPENSION SYSTEM FOR VEHICLE

(75) Inventor: Katsuyuki Sano, Miyoshi-shi (JP)

Correspondence Address: OLIFF & BERRIDGE, PLC, P.O. BOX 320850, ALEXANDRIA, VA, 22320-4850, US

(73) Assignee: TOYOTA JIDOSHA KABUSHIKI KAISHA, TOYOTA-SHI (JP)

(21) Appl. No.: 12/738,928

(22) PCT Filed: Oct. 30, 2008
(86) PCT No.: PCT/JP2008/070263

§ 371 Date: Apr. 20, 2010

(30) Foreign Application Priority Data
Nov. 14, 2007 (JP) 2007-295604

(51) Int. Cl. B60G 21/055

(52) U.S. Cl. 280/124.106

(57) ABSTRACT

A suspension system for a vehicle, including: a stabilizer apparatus configured to change a stabilizer force by an operation of an actuator; a pair of absorbers of a hydraulic type each configured to change a damping coefficient thereof: a control device which includes (a) a stabilizer-force control portion configured to control the stabilizer force in accordance with roll moment acting on a body of the vehicle and (b) a damping-coefficient control portion configured to control the damping coefficient of each of the absorbers, wherein the damping-coefficient control portion is configured to execute a damping-coefficient reduction control for reducing the damping coefficient of each of the absorbers when a prescribed condition is satisfied and wherein the stabilizer-force control portion is configured to increase the stabilizer force in an instance where the damping-coefficient reduction control is under execution, as compared with an instance where the damping-coefficient reduction control is not under execution.

### TECHNICAL FIELD

The present invention relates in general to a suspension system for a vehicle including a stabilizer apparatus configured such that a stabilizer force generated by the stabilizer apparatus is changeable by an operation of an actuator.

### BACKGROUND ART

In recent years, there has been developed and actually used a stabilizer system for a vehicle described in the following patent documents, namely, a stabilizer system including a stabilizer apparatus configured to controllably generate a stabilizer force that is based on a twist-reacting force of a stabilizer bar. Here, the twist-reacting force means a force exerted by the stabilizer bar as a result of being twisted.

Patent Document 1 JP-A-2005-238972

Patent Document 2 JP-A-2006-256539

Patent Document 3 JP-A-2007-83853

### DISCLOSURE OF THE INVENTION

### (A) Summary of the Invention

The vehicle suspension system described in each of the above-indicated Patent Documents is capable of restraining or suppressing roll of a vehicle body by applying a stabilizer force generated by the stabilizer apparatus as a roll restraining force. In the systems described in the above-indicated Patent Documents 1 and 2, the roll of the vehicle is restrained by controlling only the stabilizer force. The system described in the above-indicated Patent Document 3 includes, in addition to the stabilizer apparatus, a hydraulic shock absorber (hereinafter abbreviated as “absorber” where appropriate) configured to change a damping coefficient, and the roll of the vehicle body is restrained by controlling not only the stabilizer force but also the damping coefficient of the absorber. The suspension system equipped with the stabilizer apparatus and the hydraulic absorber in which the damping coefficient is changeable is still under development, and there is plenty of room for improvement in a manner of controlling the stabilizer force and the damping coefficient. Accordingly, the utility of the system can be enhanced by various modifications. The present invention has been developed in the situations described above, and it is therefore an object of the invention to provide a suspension system for a vehicle with high utility.

To achieve the object indicated above, a suspension system for a vehicle according to the present invention is arranged to have a stabilizer apparatus configured to change a stabilizer force by an operation of an actuator, a pair of hydraulic absorbers configured to change damping coefficients thereof, and a control device configured to control the stabilizer force in accordance with roll moment that acts on a vehicle body and to control the damping coefficients of the respective absorbers. The suspension system is configured to execute a damping-coefficient reduction control for reducing the damping coefficients of the respective absorbers when a prescribed condition is satisfied and to increase the stabilizer force generated by the stabilizer apparatus in an instance where the damping-coefficient reduction control is under execution, as compared with an instance where the damping-coefficient reduction control is not under execution.

A force generated by the absorber (hereinafter referred to as “absorber force” where appropriate) acts as a resistance force with respect to a relative movement of a sprung portion and an unsprung portion, and therefore may act as a resistance force with respect to the roll of the vehicle body. Accordingly, there may be a risk of deterioration in a roll restraining effect in an instance where the damping coefficient that is a basis of an ability to generate the absorber force is reduced, as compared with an instance where the damping coefficient is not reduced. In the present suspension system, the stabilizer force is increased in an instance where the damping-coefficient reduction control is under execution, as compared with an instance where the damping-coefficient reduction control is not under execution. In other words, the stabilizer force becomes larger in an instance where the damping-coefficient reduction control is under execution than in instance where the damping-coefficient reduction control is not under execution. Accordingly, the present suspension system is capable of preventing the roll restraining effect from being deteriorated due to a reduction of the absorber force upon turning of the vehicle, for instance.

### Forms of Claimable Invention

There will be explained various forms of an invention which is considered claimable (hereinafter referred to as “claimable invention” where appropriate). Each of the forms of the invention is numbered like the appended claims and depends from the other form or forms, where appropriate. This is for easier understanding of the claimable invention, and it is to be understood that combinations of constituent elements that constitute the invention are not limited to those described in the following forms. That is, it is to be understood that the claimable invention shall be construed in the light of the following descriptions of various forms and preferred embodiments. It is to be further understood that any form in which one or more elements is/are added to or deleted from any one of the following forms may be considered as one form of the claimable invention. The following forms (1)-(5) correspond to claims 1-5, respectively.

(1) A suspension system for a vehicle, comprising:

a stabilizer apparatus which includes an actuator and a stabilizer bar whose opposite ends are connected to left and right wheels of the vehicle, respectively, and which generates a stabilizer force that is based on a twist-reacting force of the stabilizer bar, the stabilizer force being changeable by the actuator;

a pair of absorbers of a hydraulic type each of which is provided for a corresponding one of the left and right wheels, each of which generates a damping force with respect to a relative movement of the corresponding one of the left and right wheels and a body of the vehicle, and which respectively include damping-coefficient changing mechanisms each configured to change a damping coefficient that is an ability to generate the damping force and that is a basis of a magnitude of the damping force to be generated; and

a control device which includes: a stabilizer-force control portion configured to control the stabilizer force generated by the stabilizer apparatus, by controlling the actuator in accordance with roll moment acting on the body of the vehicle due to turning of the vehicle; and a damping-coefficient control portion configured to control the damping coefficient of each of the pair of absorbers by controlling a corresponding one of the damping-coefficient changing mechanisms,

wherein the damping-coefficient control portion is configured to execute a damping-coefficient reduction control for reducing the damping coefficient of said each of the pair of absorbers when a prescribed condition is satisfied, and

wherein the stabilizer-force control portion is configured to increase the stabilizer force generated by the stabilizer apparatus in an instance where the damping-coefficient reduction control is under execution, as compared with an instance where the damping-coefficient reduction control is not under execution.

In the stabilizer apparatus configured such that the stabilizer force generated by the stabilizer apparatus is changeable by the operation of the actuator, the roll of the vehicle body can be effectively restrained by changing the stabilizer force in accordance with the roll moment that the vehicle body undergoes. However, in the vehicle in which the absorbers configured to change the damping coefficients thereof are provided, together with the stabilizer apparatus, there may be a risk that the roll restraining effect exhibited by the stabilizer apparatus is deteriorated due to changes in the damping coefficients of the absorbers. More specifically explained, since the force generated by each absorber, i.e., the absorber force, acts as a resistance force with respect to the relative movement of the sprung portion and the unsprung portion, the absorber force may act as a resistance force with respect to the roll of the vehicle body when the vehicle body suffers from the roll due to turning of the vehicle. In particular when the roll moment increases in an initial period of turning of the vehicle, the absorber force acts as the resistance force with respect to the increase in the roll of the vehicle body, thereby restraining an increase in the roll amount of the vehicle body. Accordingly, the effect of restraining the roll of the vehicle body may be deteriorated in an instance where the damping coefficient is reduced, as compared with an instance where the damping coefficient is not reduced. In the above form (1), the stabilizer force is increased when the damping coefficient is reduced. Therefore, it is possible to avoid the deterioration in the roll restraining effect due to the reduction of the absorber force upon turning of the vehicle, for instance.

The “prescribed condition” described in the above form (1) is not particularly limited. For instance, the prescribed condition may be set as follows. In a vehicle equipped with a switch or the like for changing the ride comfort of the vehicle, the running ability of the vehicle and so on, based on a driver's intension, the prescribed condition may defined as a condition that the vehicle is in a pre-set state as a result of a manipulation of the switch or the like by the driver. Further, the prescribed condition may be defined as a condition that the ride comfort of the vehicle is supposed to be deteriorated, more specifically, a condition that the vehicle is supposed to be running on a bad road which will be explained. When the stabilizer force is increased as described in the above form (1), it may be possible to increase the stabilizer force in accordance with a degree of reduction of the damping coefficient in the damping-coefficient reduction control. More specifically explained, the stabilizer force may be made large with an increase in the degree of reduction of the damping coefficient in the damping-coefficient reduction control.

The structure of the “stabilizer apparatus” described in the above form (1) is not particularly limited. As explained below, the stabilizer apparatus may have a structure in which a stabilizer bar is constituted by a pair of stabilizer bar members obtained by dividing the stabilizer bar in two at its middle portion and the actuator disposed between the pair of stabilizer bar members permit the pair of stabilizer bar members to rotate relative to each other, thereby twisting the stabilizer bar. Further, the stabilizer apparatus may have a structure in which the actuator disposed between one end of the stabilizer bar and a wheel-holding member changes a distance between the above-indicted one end and the wheel-holding member, thereby twisting the stabilizer bar. The “stabilizer force” described in the above form (1) is a force by which a distance between the sprung portion and the unsprung portion for the left wheel and a distance between the sprung portion and the unsprung portion for the right wheel are changed relative to each other. By the stabilizer force, the sprung portion and the unsprung portion for one of the left and right wheels can be moved toward each other while the sprung portion and the unsprung portion for the other of the left and right wheels can be moved away form each other.

The structure of the “absorber” described in the above form (1) is not particularly limited. There may be employed an absorber of a hydraulic type conventionally used. The “damping-coefficient changing mechanism” described in the above form (1) may be configured to change the damping coefficient continuously or in steps among two or more pre-set values.

(2) The suspension system according to the form (1), wherein the damping-coefficient reduction control is executed when a prescribed bad-road running condition in which the vehicle is supposed to be running on a bad road is satisfied, the prescribed bad-road running condition being defined as the prescribed condition.

In the above form (2), the condition for executing the damping-coefficient reduction control is specifically limited. When the vehicle runs on the bad road, the vibration is transmitted from the wheel to the vehicle body due to unevenness of the road surface, whereby the ride comfort of the vehicle may be undesirably deteriorated. The value of the damping coefficient of the absorber influences the transmission property of the vibration, namely, the degree of transmission of the vibration, from the wheel to the vehicle body. Where the frequency of the vibration is relatively high, the vibration transmission property becomes lower with a decrease in the damping coefficient. The frequency of the vibration inputted from the wheel during running on the bad road is generally high. Accordingly, it is possible in the above form (2) to lower the transmission property of the vibration inputted from the wheel to the vehicle body during running on the bad road.

The “bad road” described in the above form (2) is defined as a road whose surface is not smooth, in other words, a road from which the vibration, especially, the vibration in a relatively high frequency range, is inputted so as to be transmitted from the wheel to the vehicle body during running of the vehicle on the road.

(3) The suspension system according to the form (2), wherein the prescribed bad-road running condition is defined as a condition that an intensity of a vibration in a specific frequency range among vibrations inputted to the body from the wheel exceeds a threshold.

In the above form (3), the bad-road running condition is specifically limited. The vibration inputted from the wheel during running of the bad road tends to include the vibration in the specific frequency range, more specifically, the vibration in the relatively high frequency range. According to the above form (3), it is possible to appropriately judge whether the road on which the vehicle is running is the bad road or not. The “specific frequency range” described in the above form (3) is a range in which the vibration is likely to be transmitted from the wheel to the vehicle body during running on the bad road, e.g., the relatively high frequency range, more specifically, an unsprung resonance frequency range. The “intensity of a vibration” described in the above form (3) indicates a component of the vibration such as the amplitude, acceleration or the like, of the vibration.

(4) The suspension system according to any one of the forms (1)-(3),

wherein the stabilizer bar is constituted by a pair of stabilizer bar members each of which includes a torsion bar portion disposed so as to extend in a width direction of the vehicle and an arm portion which extends continuously from the torsion bar portion so as to intersect the torsion bar portion and which is connected at a leading end portion thereof to a wheel-holding portion that holds a corresponding one of the left and right wheels, and

wherein the actuator is configured to rotate the torsion bar portions of the pair of stabilizer bar members relative to each other.

In the above form (4), the structure of the stabilizer apparatus, more specifically, the structure of the stabilizer bar and the actuator, is limited. According to the above form (4), the stabilizer force generated by the stabilizer apparatus can be efficiently changed.

(5) The suspension system according to the form (4),

wherein the actuator includes an electromagnetic motor as a drive source, a decelerator which decelerates rotation of the electromagnetic motor, and a housing which holds the electromagnetic motor and the decelerator, and

wherein the torsion bar portion of one of the pair of stabilizer bar members is connected to the housing so as to be unrotatable relative to the housing while the torsion bar portion of the other of the pair of stabilizer bar members is connected to an output portion of the decelerator so as to be unrotatable relative to the output portion.

In the above form (5), the structure of the actuator, the connection manner of the actuator and the stabilizer bar, and the dispositional relationship of the actuator and the stabilizer bar are specifically limited. The mechanism of the decelerator of the actuator is not particularly limited. There may be employed decelerators of various mechanisms such as a harmonic gear mechanism (called “HARMONIC DRIVE” (trademark) mechanism and also called “strain wave gear ring mechanism”) and a hypocycloid decelerating mechanism. For downsizing the electromagnetic motor, it is preferable that the reduction ratio of the decelerator be relatively large. In this respect, the large reduction ratio means that the operational amount of the actuator with respect to the operation amount of the electromagnetic motor is small. In view of this, the decelerator that employs the harmonic gear mechanism is suitable in the system according to the above form (5).

### BRIEF DESCRIPTION OF THE DRAWINGS

FIG. 1 is a schematic view showing an overall structure of a suspension system for a vehicle according to one embodiment of the claimable invention.

FIG. 2 is a schematic view showing a stabilizer apparatus and suspension apparatuses of the suspension system of FIG. 1, as viewed from above the vehicle.

FIG. 3 is a schematic view showing the stabilizer apparatus and the suspension apparatuses of the suspension system of FIG. 1, as viewed from a front side of the vehicle.

FIG. 4 is a cross sectional view of a hydraulic shock absorber of each suspension apparatus.

FIG. 5 is an enlarged cross sectional view of the shock absorber of FIG. 4.

FIG. 6 is a cross sectional view of an actuator of the stabilizer apparatus.

FIG. 7 is map data showing a relationship between control-use lateral acceleration and target motor rotational angle, in a normal condition.

FIG. 8 is a graph conceptually showing a relationship between vibration frequency and vibration transmission property from an unsprung portion to a sprung portion.

FIG. 9 is map data showing a relationship between control-use lateral acceleration and target motor rotational angle in an instance where a damping-coefficient reduction control is under execution.

FIG. 10 is a flow chart showing an absorber control program.

FIG. 11 is a flow chart showing a stabilizer-apparatus control program.

FIG. 12 is a block diagram showing functions of a control device which governs a control of the suspension system.

FIG. 13 is map data showing a relationship between control-use lateral acceleration and target motor rotational angle in a case where a plurality of reduced damping coefficients are set.

### BEST MODE FOR CARRYING OUT THE INVENTION

There will be described in detail one embodiment according to the claimable invention, referring to the drawings. It is to be understood, however, that the claimable invention is not limited to the details of the following embodiment but may be embodied with various changes and modifications, such as those described in the FORMS OF THE CLAIMABLE INVENTION, which may occur to those skilled in the art.

### 1. Structure of Suspension System

### 1.1. Overall Structure of Suspension System

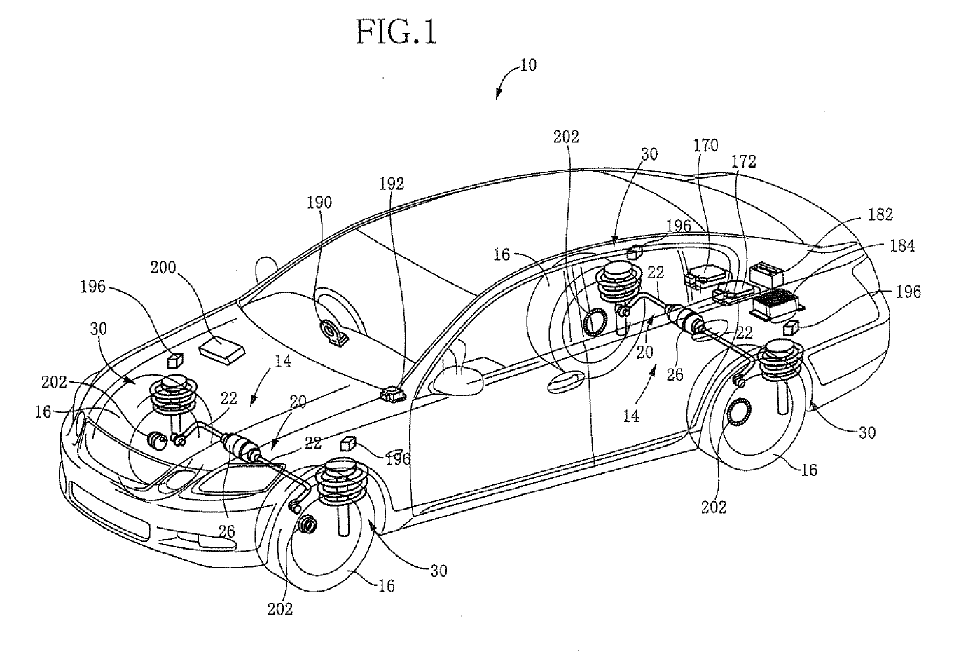

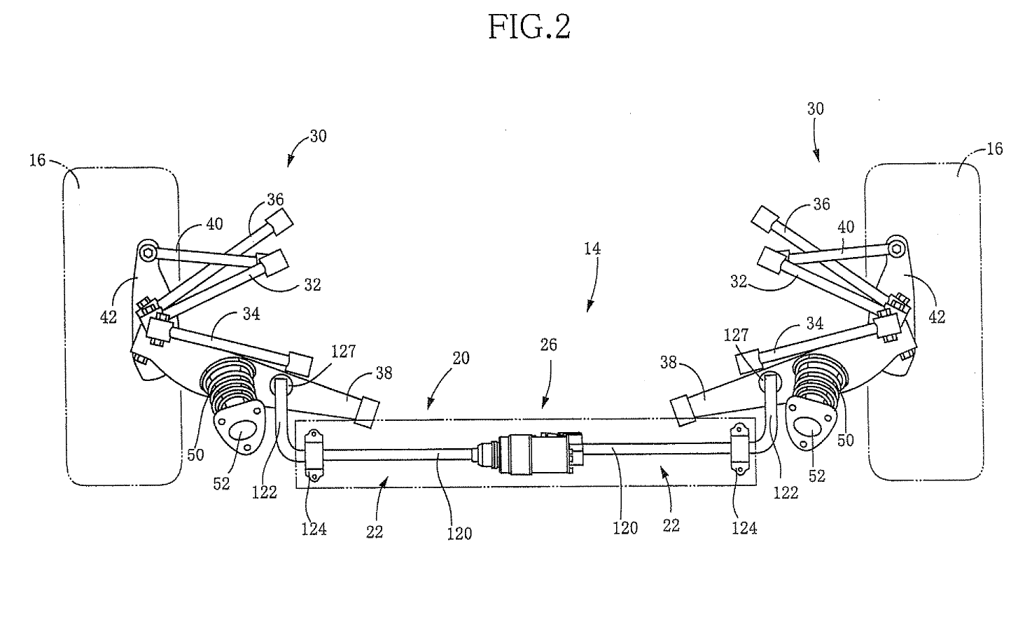

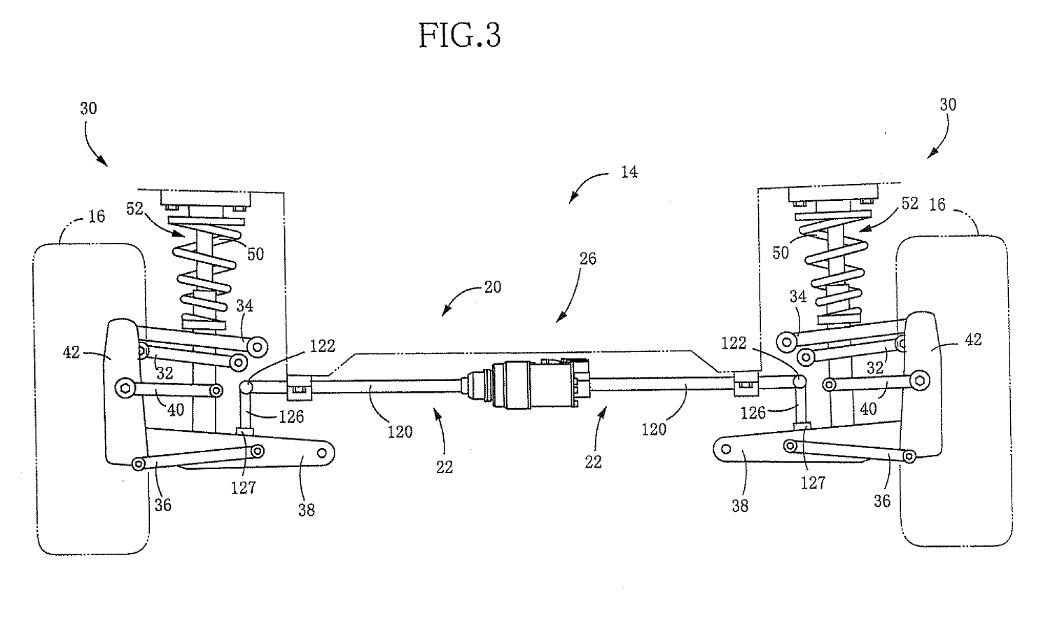

FIG. 1 schematically shows a suspension system 10 for a vehicle according to the present embodiment. The suspension system 10 includes a pair of stabilizer apparatuses 14, 14 which are respectively disposed on a front-wheel side and a rear-wheel side, of the vehicle. Each stabilizer apparatus 14 includes a stabilizer bar 20 whose opposite ends are respectively connected to wheel-holding members in the form of suspension arms (FIGS. 2 and 3) for holding left and right wheels 16, respectively. The stabilizer bar 20 is divided into two portions so as to include a pair of stabilizer bar members 22, 22. The pair of stabilizer bar members 22, 22 are connected by an actuator 26 so as to be rotatable relative to each other.

In the vehicle on which the present suspension system 10 is mounted, four suspension apparatuses are disposed so as to correspond to the respective four wheels 16. Two of the four suspension apparatuses for the respective two front wheels that can be steered are substantially identical in construction with another two of the four suspension apparatuses for the respective two rear wheels that cannot be steered, except for a mechanism that enables the wheels to be steered. Accordingly, the suspension apparatuses for the rear wheels are explained for the sake of brevity. Each suspension apparatus generally indicated at 30 in FIGS. 2 and 3 is of an independent type and a multi link type. The suspension apparatus 30 includes a first upper arm 32, a second upper arm 34, a first lower arm 36, a second lower arm 38, and a toe control arm 40, each as the suspension arm. One end of each of the five arms 32, 34, 36, 38, 40 is rotatably connected to a body of the vehicle while the other end is rotatably connected to an axle carrier 42 which rotatably holds a corresponding one of the four wheels 16. Owing to the five arms 32, 34, 36, 38, 40, the axle carrier 42 is vertically movable relative to the vehicle body along a substantially constant locus. The suspension apparatus 30 includes a coil spring 50 and a hydraulic shock absorber (hereinafter abbreviated as “absorber” where appropriate) 52 which are disposed in parallel with each other between the second lower arm 38 and a mount portion 54 that is provided in a tire housing.

### 1.2. Structure of Absorber

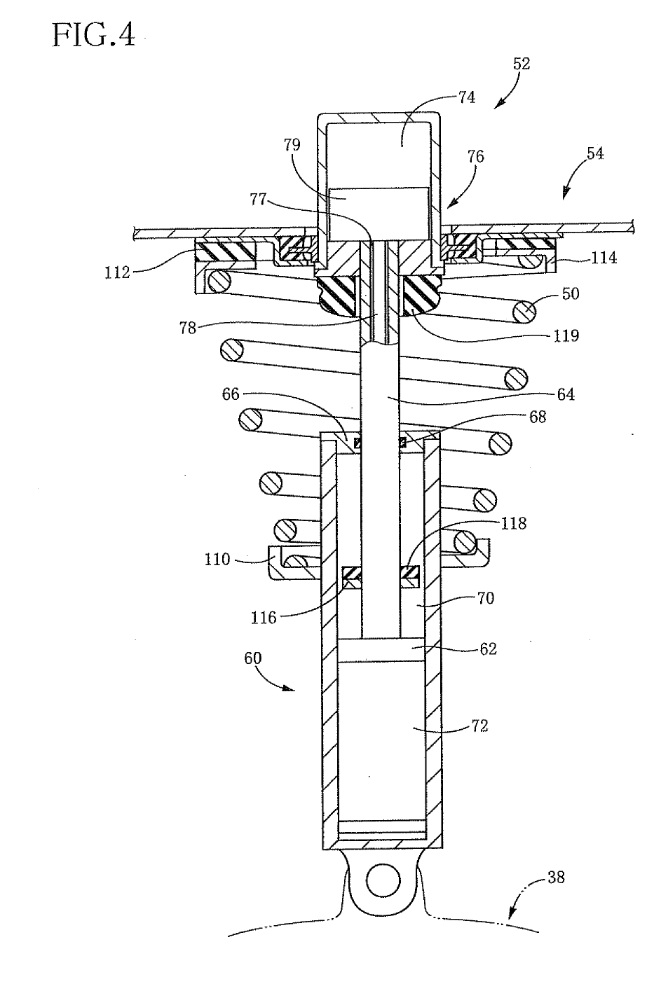

As shown in FIG. 4, the absorber 52 includes: a generally cylindrical housing 60 which is connected to the second lower aria 38 and which accommodates a working fluid; a piston 62 fluid-tightly and slidably fitted in an inside of the housing 60; and a piston rod 64 connected at its lower end to the piston 62 and extending, at its upper end, upward beyond the top of the housing 60. The piston rod 64 penetrates through a cap portion 66 disposed on the upper portion of the housing 60 and is held in sliding contact with the cap portion 66 via a seal 68. The inside of the housing 60 is divided into an upper chamber 70 located on an upper side of the piston 62 and a lower chamber 72 located on a lower side of the piston 62.

The absorber 52 further includes an electromagnetic motor 74 which is fixedly housed in a motor casing 76. The motor casing 76 is connected at its outer circumferential portion to the mount portion 54 via a cushion rubber. The piston rod 64 is fixedly connected at its upper end to the motor casing 76. Thus, the piston rod 64 is fixed with respect to the mount portion 54. The piston rod 64 is a hollow member and has a through-hole 77 which extends through an inside of the piston rod 64. As explained below in detail, an adjustment rod 78 is inserted into the through-hole 77 so as to be movable in an axis direction of the piston rod 64, namely, in an axis direction of the absorber 52. The adjustment rod 78 is connected at its upper end to the electromagnetic motor 74. More specifically explained, there is disposed, below the electromagnetic motor 74, a motion converting mechanism 79 for converting the rotation of the electromagnetic motor 74 into the movement of the adjustment rod 78 in the axis direction. The upper end of the adjustment rod 78 is connected to the motion converting mechanism 79. In this structure, the adjustment rod 78 is configured to be moved in the axis direction when the electromagnetic motor 74 is operated.

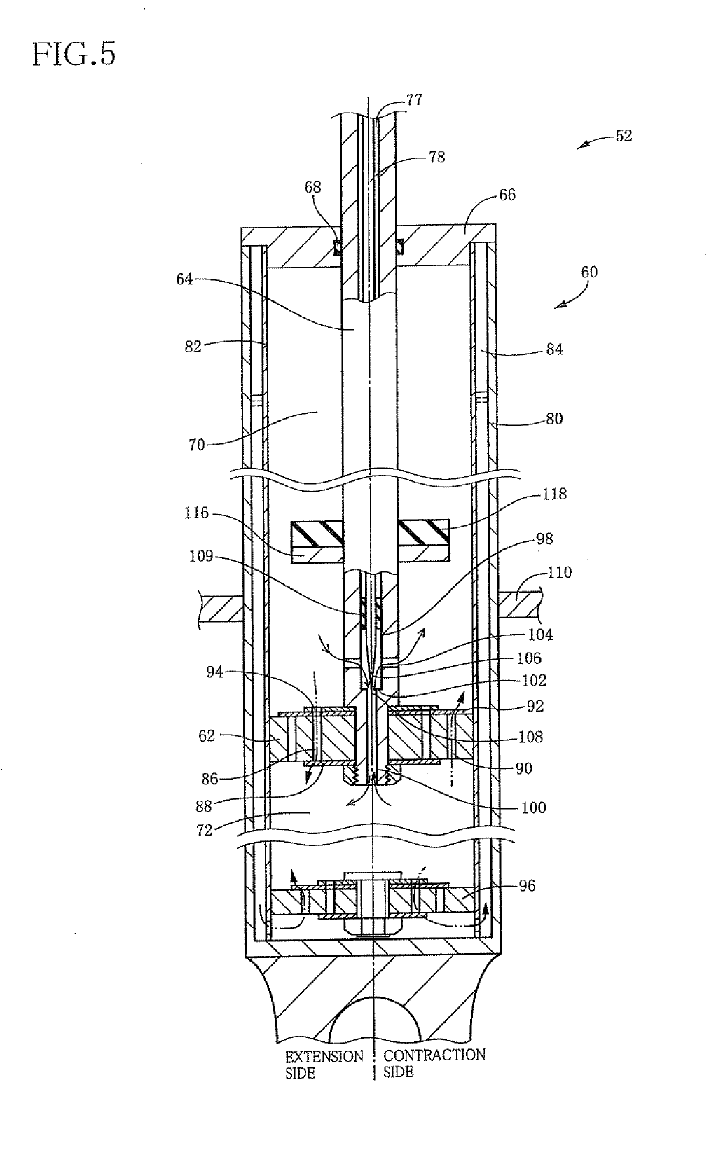

As shown in FIG. 5, the housing 60 is comprised of an outer cylindrical member 80 and an inner cylindrical member 82 between which a buffer chamber 84 is formed. The piston 62 is fluid-tightly and slidably fitted in the inner cylindrical member 82. The piston 62 has a plurality of communication passages 86 (two of which are shown in FIG. 5) which are formed through the thickness of the piston 62 so as to extend in the axis direction and through which the upper chamber 70 and the lower chamber 72 communicate with each other. A disk-like valve plate 88 formed of an elastic material is disposed on a lower surface of the piston 62 so as to be held in contact with the lower surface. Openings of the communication passages 86 on the side of the lower chamber 72 are closed by the valve plate 88. The piston 62 further has a plurality of communication passages 90 (two of which are shown in FIG. 5) which are located apart from the above-indicated communication passages 86 in the radial direction. A disk-like valve plate 92 formed of an elastic material is disposed on an upper surface of the piston 62 so as to be held in contact with the upper surface. Openings of the communication passages 90 on the side of the upper chamber 70 are closed by the valve plate 92. Each communication passage 90 is located at a position which is radially outwardly of each communication passage 86 and which is outside the valve plate 88 in the radial direction. Accordingly, the communication passages 90 are normally kept in communication with the lower chamber 72. Openings of the communication passages 86 on the side of the upper chamber 70 are kept open, namely, are not closed, owing to openings 94 formed in the valve plate 92, whereby the communication passages 86 are normally kept in communication with the upper chamber 70. Further, the lower chamber 72 and the buffer chamber 84 are held in communication with each other, and there is disposed, between the lower chamber 72 and the buffer chamber 84, a base valve member 96 having communication passages and valve plates similar to those formed in the piston 62.

The through-hole 77 formed in the piston rod 64 includes a large-diameter portion 98 and a small-diameter portion 100 that extends downwardly from the large-diameter portion 98. A stepped surface 102 is formed at a boundary between the large-diameter and small-diameter portions 98, 100. Communication passages 104 that permit communication between the upper chamber 70 and the through-hole 77 are formed above the stepped surface 102. The upper chamber 70 and the lower chamber 72 are held in communication with each other by the communication passages 104 and the through-hole 77. The adjustment rod 78 is inserted into the large-diameter portion 98 of the through-hole 77 from the upper end of the piston rod 64. The lower end of the adjustment rod 78 is formed into a conical portion 106. The leading end of the conical portion 106 is insertable into the small-diameter portion 100 of the through-hole 77. Between the conical portion 106 and the stepped surface 102 of the through-hole 77, a clearance 108 is formed. It is noted that the outside diameter of the adjustment rod 78 is made larger than the inside diameter of the small-diameter portion 100 of the through-hole 77. At a portion of the through-hole 77 above the communication passages 104, a seal 109 is provided between the inner circumferential surface of the through-hole 77 and the outer circumferential surface of the adjustment rod 78, thereby preventing the working fluid from flowing into an upper portion of the through-hole 77.

In the structure described above, when the sprung portion and the unsprung portion are moved away from each other and the piston 62 is moved upward, namely, when the absorber 52 extends, a part of the working fluid in the upper chamber 70 flows into the lower chamber 72 through the communication passages 86 and the clearance 108 of the through-hole 77 while a part of the working fluid in the buffer chamber 84 flows into the lower chamber 72 through the communication passages of the base valve member 96. On this occasion, a resistance force is given to the upward movement of the piston 62 owing to the flow of the working fluid into the lower chamber 72 as a result of deflection of the valve plate 88 caused by the working fluid, owing to the flow of the working fluid into the lower chamber 72 as a result of deflection of the valve plate of the base valve member 96 caused by the working fluid, and owing to passage of the working fluid through the clearance 108 of the through-hole 77. Accordingly, there is generated, by the resistance force, a damping force with respect to the upward movement of the piston 62. On the other hand, when the sprung portion and the unsprung portion are moved toward each other and the piston 62 is moved downward in the housing 60, namely, when the absorber 52 contracts, a part of the working fluid in the lower chamber 72 flows into the upper chamber 70 through the communication passages 90 and the clearance 108 of the through-hole 77 while flowing into the buffer chamber 84 through the communication passages of the base valve member 96. On this occasion, a resistance force is given to the downward movement of the piston 62 owing to the flow of the working fluid into the upper chamber 70 as a result of deflection of the valve plate 92 caused by the working fluid, owing to the flow of the working fluid into the buffer chamber 84 as a result of deflection of the valve plate of the base valve member 96 caused by the working fluid, and owing to the passage of the working fluid through the clearance 108 of the through-hole 77. Accordingly, there is generated, by the resistance force, a damping force with respect to the downward movement of the piston 62. That is, the absorber 52 is configured to generate the damping force with respect to the relative movement of the sprung portion and the unsprung portion.

As explained above, the adjustment rod 78 is movable in the axis direction by the operation of the electromagnetic motor 74 and is configured to change the size (the cross sectional area) of the clearance 108 of the through-hole 77. When the working fluid passes through the clearance 108, the resistance force is given to the upward or downward movement of the piston 62 as described above. The magnitude of the resistance force varies depending upon the size of the clearance 108. Therefore, the absorber 52 is configured to change a damping characteristic with respect to the relative movement of the sprung portion and the unsprung portion toward or away from each other, namely, to change a so-called damping coefficient, by moving the adjustment rod 78 in the axis direction owing to the operation of the electromagnetic motor 74 and thereby changing the size of the clearance 108. In more detail, the electromagnetic motor 74 is controlled such that its rotational angle is equal to a value which corresponds to the damping coefficient that the absorber 52 should have, thereby changing the damping coefficient of the absorber 52. In this regard, the electromagnetic motor 74 is a stepping motor configured to stop at predetermined rotational angle positions. More specifically explained, when the rotational angle position of the electromagnetic motor 74 is changed, the motor 74 is driven so as to rotate based on a command that permits the motor 74 to rotate at a predetermined operational position. It is noted that there are set, as the damping coefficient of the absorber 52, two values, i.e., a first damping coefficient C₁ and a second damping coefficient C₂ that is smaller than the first damping coefficient C₁. The absorber 52 is configured such that the damping coefficient is changeable between the first damping coefficient C₁ and the second damping coefficient C₂. The thus constructed absorber 52 is equipped with a damping-coefficient changing mechanism constituted by the electromagnetic motor 74, the through-hole 77, the adjustment rod 78, the communication passage 104, and so on.

An annular lower retainer 110 is provided on the outer circumferential portion of the housing 60 while an annular upper retainer 114 is attached to the underside of the mount portion 54 via a vibration damping rubber 112. The coil spring 50 is supported by the lower and upper retainers 110, 114 so as to be sandwiched therebetween. At a position of the outer circumferential portion of the piston rod 64 accommodated in the upper chamber 70, an annular member 116 is fixed. An annular cushion rubber 118 is attached to the upper surface of the annular member 116. A cylindrical cushion rubber 119 is attached to the lower surface of the motor casing 76. When the vehicle body and the wheel move relative to each other to a certain degree in a direction away from each other (hereinafter referred to as “rebound direction” where appropriate), the annular member 116 comes into contact with the lower surface of the cap portion 66 of the housing 60 via the cushion rubber 118. On the other hand, when the vehicle body and the wheel move relative to each other to a certain degree in a direction toward each other (hereinafter referred to as “bound direction” where appropriate), the upper surface of the cap portion 66 comes into contact with the lower surface of the motor casing 76 via the cushion rubber 119. In other words, the absorber 52 is equipped with stoppers, i.e., a bound stopper and a rebound stopper, with respect to the movements of the vehicle body and the wheel toward and away from each other, respectively.

### 1.3. Structure of Stabilizer Apparatus

As shown in FIGS. 2 and 3, each stabilizer bar member 22 of the stabilizer apparatus 14 includes a torsion bar portion 120 extending generally in the width direction of the vehicle and an arm portion 122 extending integrally from the torsion bar portion 120 generally in the frontward direction of the vehicle so as to intersect the torsion bar portion 120. The torsion bar portion 120 of each stabilizer bar member 22 is rotatably supported, at a position thereof near to the arm portion 122, by a holding member 124 fixedly disposed on the vehicle body. The torsion bar portions 120 of the respective stabilizer bar members 22 are disposed coaxially relative to each other. One end of each torsion bar portion 120 which is opposite to the other end thereof near to the arm portion 122 is connected to the actuator 26 as explained below in detail. One end of each arm portion 122 which is opposite to the other end thereof near to the torsion bar portion 120 is connected to the second lower arm 38 via a link rod 126. The second lower arm 38 is provided with a ling-rod connecting portion 127. One end of the link rod 126 is swingably connected to the link-rod connecting portion 127 while the other end thereof is swingably connected to the above-indicated one end of the arm portion 122.

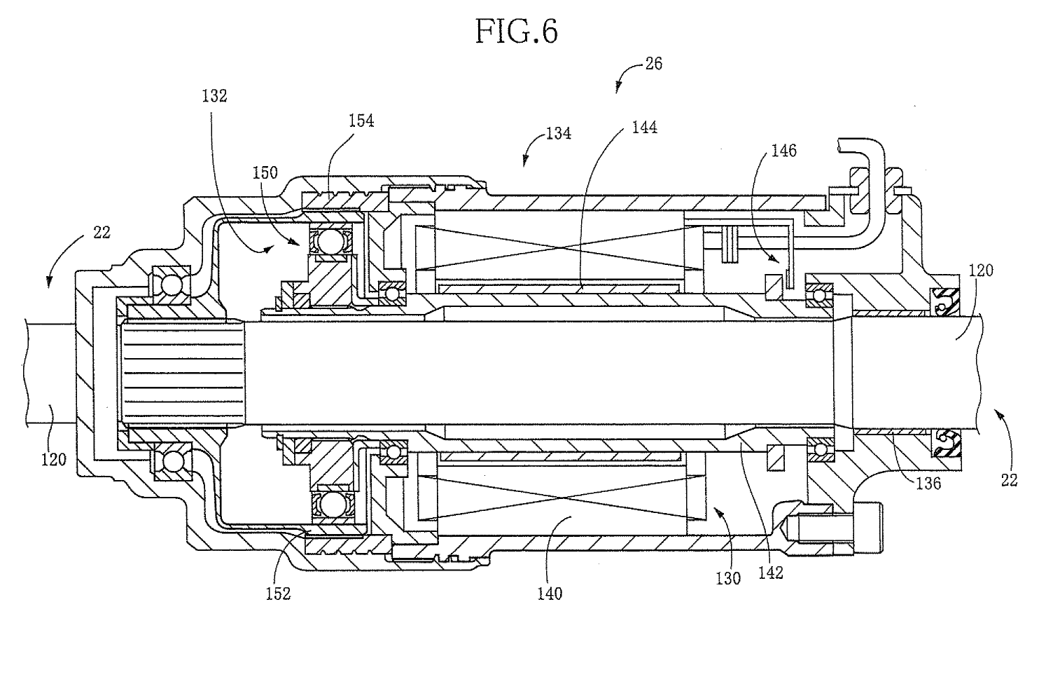

As shown in FIG. 6, the actuator 26 of the stabilizer apparatus 14 includes an electromagnetic motor 130 as a drive source and a decelerator 132 configured to decelerate rotation of the electromagnetic motor 130. The electric motor 130 and the decelerator 132 are disposed in a housing 134 as an outer shell member of the actuator 26. The above-indicated one end of the torsion bar portion 120 of one of the pair of stabilizer bar members 22 is fixedly connected to one of opposite ends of the housing 134. The other of the pair of stabilizer bar members 22 is disposed so as to extend into the housing 134 at the other of the opposite ends of the housing 134 and is connected to the decelerator 132 as explained below in detail. Further, the other of the pair of stabilizer bar members 22 is rotatably held, at its axially intermediate portion, by the housing 134 via a bush bearing 136.

The electromagnetic motor 130 includes: a plurality of coils 140 fixedly disposed on one circumference along an inner circumferential surface of the cylindrical wall of the housing 134; a hollow motor shaft 142 rotatably held by the housing 134; and permanent magnets 144 fixedly disposed on the outer circumference of the motor shaft 142 so as to face the coils 140. The electric motor 130 is a motor in which the coils 140 function as a stator and the permanent magnets 144 function as a rotor, and is a three-phase DC brushless motor. In the housing 134, there is disposed a motor-rotational-angle sensor 146 for detecting a rotational angle of the motor shaft 142, namely, a rotational angle of the electromagnetic motor 130. The motor-rotational-angle sensor 146 is constituted principally by an encoder and utilized in the control of the actuator 26, namely in the control of the stabilizer apparatus 14.

In the present embodiment, the decelerator 132 is constituted as a harmonic gear mechanism (called “HARMONIC DRIVE (trademark) mechanism” and also called “strain wave gear ring mechanism”) including a wave generator 150, a flexible gear 152, and a ring gear 154. The wave generator 150 includes an oval cam and ball bearings fitted on a periphery of the cam, and is fixed to one end of the motor shaft 142. The flexible gear 152 is a cup-like member whose cylindrical wall portion is elastically deformable. A plurality of teeth (400 teeth in the present decelerator 132) are formed on an outer circumference of the open end portion of the cup-like flexible gear 152. The flexible gear 152 is connected to and held by the above-indicated one end of the torsion bar portion 120 of the other of the pair of stabilizer bar members 22. More specifically explained, the torsion bar portion 120 of the other of the pair of stabilizer bar members 22 penetrates the motor shaft 142 and has an end portion extending from or beyond the one end of the motor shaft 142. To the outer circumferential surface of this end portion, a bottom portion of the flexible gear 152 as the output portion of the decelerator 132 is connected by spline fitting so as to be unrotatable relative to each other, with the end portion penetrating the bottom portion of the flexible gear 152. The ring gear 154 is a generally ring-like member and is fixed to the housing 134. A plurality of teeth (402 teeth in the present decelerator 132) are formed on an inner circumference of the ring gear 154. The flexible gear 152 is fitted at its cylindrical wall portion on the wave generator 150 and is elastically deformed into an oval shape. The flexible gear 152 meshes the ring gear 154 at two portions thereof corresponding to opposite ends of the long axis of the oval and does not mesh the same 154 at portions thereof other than the two portions. In the thus constructed decelerator 132, with one rotation of the wave generator 150 (i.e., after rotation of the wave generator 150 by (360°, in other words, after one rotation of the motor shaft 142 of the electromagnetic motor 130, the flexible gear 152 and the ring gear 154 are rotated relative to each other by an amount corresponding to the two teeth. That is, the reduction ratio of the decelerator 132 is made equal to 1/200.

In the thus constructed stabilizer apparatus 14, where the vehicle body undergoes, due to turning of the vehicle, a force which changes the distance between one of the right and left wheels 16 and the vehicle body and the distance between the other of the right and left wheels 16 and the vehicle body relative to each other, namely, where the vehicle body undergoes roll moment, the actuator 26 receives a force acting thereon which rotates the right and left stabilizer bar members 22 relative to each other, i.e., an external input force. In this instance, when the actuator 26 generates a counterforce with respect to the external input force owing to a force of the electromagnetic motor 130 (i.e., a motor force) that is generated by the electromagnetic motor 130, one stabilizer bar 20 constituted by the two stabilizer bar members 22 is twisted. A twist-reacting force generated by the twisting of the stabilizer bar 20 functions as a counterforce with respect to the roll moment. In other words, a stabilizer force generated by the stabilizer apparatus 14 based on the twist-reacting force of the stabilizer bar 20 is applied to a roll restraining force. Where the relative rotational amount of the left and right stabilizer bar members 22 is changed by changing the rotational amount of the actuator 26 owing to the motor force, the above-indicated stabilizer force is changed, making it possible to actively restrain the roll of the vehicle body. Here, since the electromagnetic motor 130 is a rotation motor, the motor force can be considered as a rotational torque. Accordingly, the motor force may be referred to as the rotational torque.

Here, the rotational amount of the actuator 26 means the following: A state in which the vehicle is kept at rest on a flat road is defined as a basic state. Where the rotational position of the actuator 26 in the basic state is defined as a neutral position, the rotational amount of the actuator 26 indicates an amount of rotation, i.e., an amount of operation, from the neutral position. Accordingly, with an increase in the rotational amount of the actuator 26, the relative rotational amount of the left and right stabilizer bar members 22 increases, and the twist-reacting force of the stabilizer bar 20, namely, the stabilizer force, accordingly increases. Since there is correspondence relationship between the rotational amount of the actuator 26 and the rotational angle of the electromagnetic motor 130, there is executed, in the control of the present system 10, a control which is targeted at the motor rotational angle obtained by the motor-rotational-angle sensor 146, in place of the rotational amount of the actuator 26. In other words, in the present system 10, the stabilizer force generated by the stabilizer apparatus 14 increases with an increase in the motor rotational angle of the electromagnetic motor 130.

### 1.4. Structure of Control Device

As shown in FIG. 1, the present system 10 includes a stabilizer-apparatus electronic control unit (stabilizer-apparatus ECU) 170 which executes a control for the pair of stabilizer apparatuses 14 and an absorber electronic control unit (absorber ECU) 172 which executes a control for the four absorbers 52. The ECU 170 and the ECU 172 cooperate with each other to constitute a control device of the present suspension system 10.

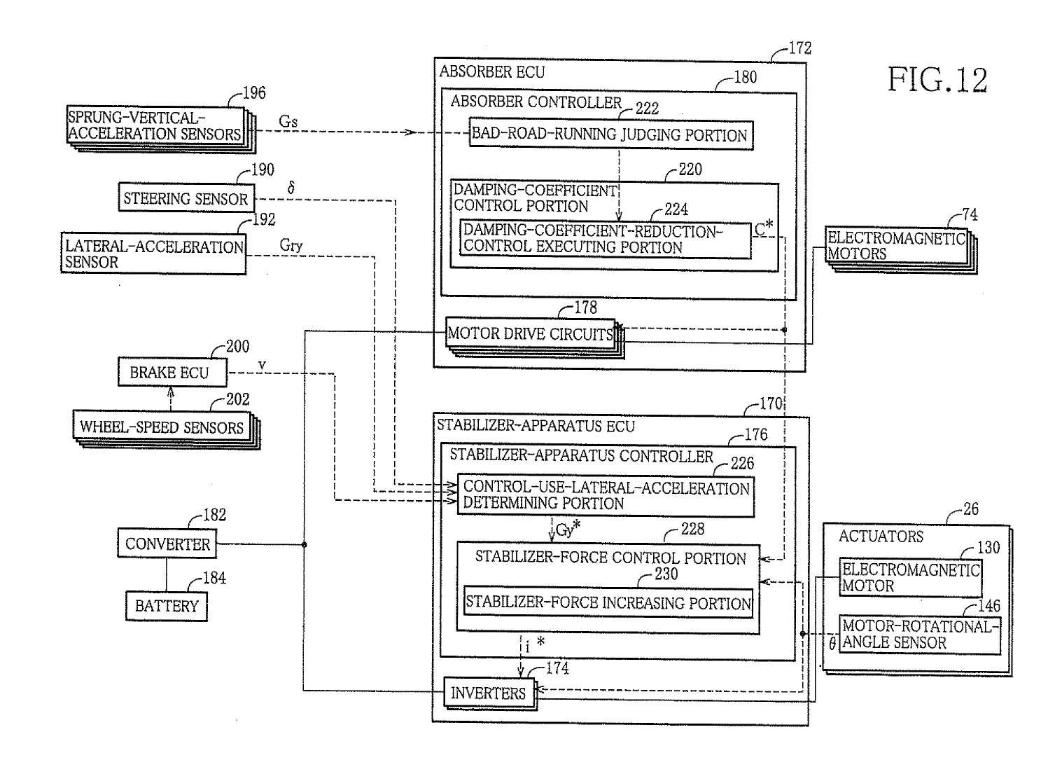

The stabilizer-apparatus ECU 170 is the control device for controlling the operation of the actuator 26 of each stabilizer apparatus 14 and includes: two inverters 174, each as a drive circuit, which respectively correspond to the electromagnetic motors 130 of the respective actuators 26; and a stabilizer-apparatus controller 176 constituted mainly by a computer including a CPU, a ROM, a RAM, etc., as shown in FIG. 12. The absorber ECU 172 is the control device for controlling the operation of the electromagnetic motor 74 of each absorber 52 and includes: four motor drive circuits 178 each as a drive circuit; and an absorber controller 180 constituted mainly by a computer including a CPU, a ROM, a RAM, etc., as shown in FIG. 12. The inverters 174 and the motor drive circuits 178 are connected to a battery 184 via a converter 182. The inverters 174 are connected to the corresponding electromagnetic motors 130 of the respective stabilizer apparatuses 14 while the motor drive circuits 178 are connected to the corresponding electromagnetic motors 74 of the respective absorbers 52.

Each of the electromagnetic motors 130 of the respective actuators 26 in the stabilizer apparatuses 14 is configured to be driven at a constant voltage, and the amount of electric power to be supplied to the electromagnetic motor 130 is changed by changing the amount of electric current to be supplied. In this respect, the supply amount of electric current is changed such that the corresponding inverter 174 changes a ratio (duty ratio) of a pulse-on time to a pulse-off time by PWM (Pulse Width Modulation).

To the stabilizer-apparatus controller 176, there are connected, in addition to the motor-rotational-angle sensors 146, a steering sensor 190 for detecting an operational angle of the steering wheel that is an operational amount of the steering operating member as a steering amount and a lateral-acceleration sensor 192 for detecting actual lateral acceleration that is lateral acceleration actually generated in the vehicle body. There is further connected, to the stabilizer-apparatus controller 176, a brake electronic control unit (hereinafter referred to as “brake ECU” where appropriate) 200 as a control device for a brake system. To the brake ECU 200, there are connected four wheel-speed sensors 202 which are provided for the respective four wheels 16 for detecting rotational speeds of the respective wheels 16. The brake ECU 200 has a function of estimating a running speed of the vehicle (hereinafter referred to as “vehicle speed” where appropriate) based on values detected by the respective wheel-speed sensors 202. The stabilizer-apparatus controller 176 is configured to obtain the vehicle speed from the brake ECU 200 as needed. The stabilizer-apparatus controller 176 is connected to the inverters 174 for controlling the same 174, thereby controlling the electromagnetic motors 130 of the respective stabilizer apparatuses 14. The ROM of the computer of the stabilizer-apparatus controller 176 stores programs, various data, and so on relating to the control of each stabilizer apparatus 14 as explained below.

To the absorber controller 180, there are connected sprung-vertical-acceleration sensors 196. Each sprung-vertical-acceleration sensor 196 is disposed on the corresponding mount portion 54 of the vehicle body for detecting sprung vertical acceleration for the corresponding wheel. The absorber controller 180 is connected to each of the motor drive circuits 178 for controlling the same 178, thereby controlling the electromagnetic motor 74 of each of the absorbers 52. The ROM of the computer of the absorber controller 180 stores programs, various data, and so on relating to the control of each absorber 52 as explained below. The stabilizer-apparatus controller 176 and the absorber controller 180 are connected so as to be communicable with each other, whereby information, commands, and so on relating to the control of the present suspension system 10 are transmitted between stabilizer-apparatus controller 176 and the absorber controller 180, as needed.

### 2. Control of Suspension System

### 2.1. Basic Control of Stabilizer Apparatus

In the present suspension system 10, there is executed, in order to restrain roll of the vehicle body, a roll restraining control in which an actual motor rotation angle θ that is an actual rotational angle of each of the electromagnetic motors 130 of the respective stabilizer apparatuses 14 coincides with a target motor rotational angle θ*. In more detail, the target motor rotational angle θ* of each electromagnetic motor 130 is determined in accordance with the roll moment that the vehicle body undergoes, for generating the stabilizer force in accordance with the roll moment that the vehicle body undergoes. Further, the actual motor rotational angle θ of the electromagnetic motor 130 is controlled so as to coincide with the target motor rotational angle θ*.

More specifically explained, there is determined, according to the following formula, the control-use lateral acceleration Gy* that is to be utilized in the control, based on: the estimated lateral acceleration Gyc that is estimated on the basis of the steering angle δ of the steering wheel and the vehicle running speed v; and actual lateral acceleration Gyr that is actually measured:

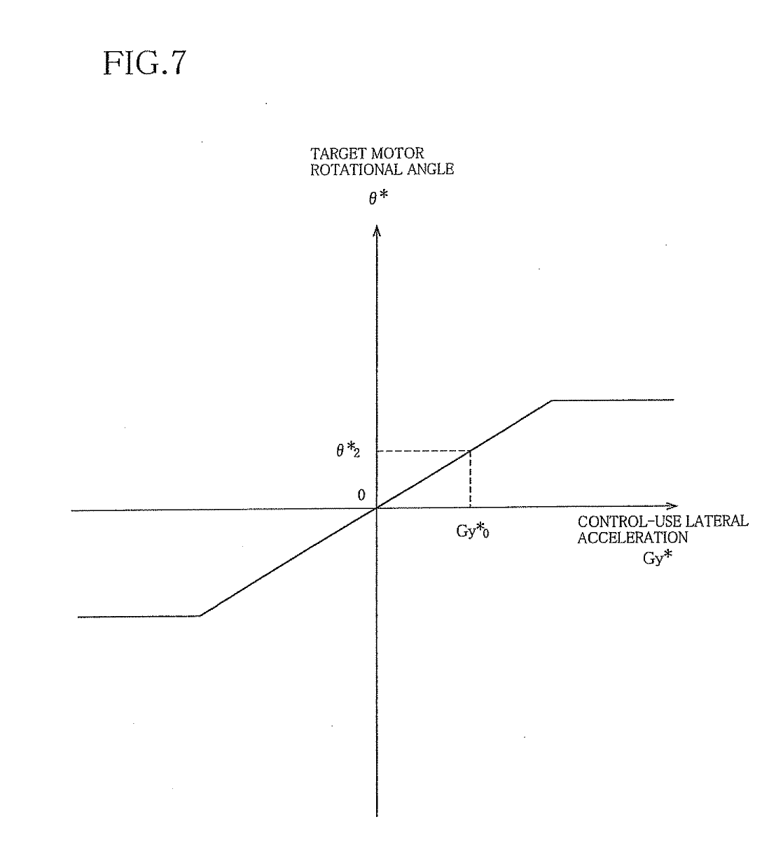

Gy*=K_{A}·Gyc+K_{B}·Gyr

wherein K_{A} and K_{B} are gains. The target motor rotational angle θ* is determined based on the thus determined control-use lateral acceleration Gy*. There is stored, in the stabilizer-apparatus controller 176, map data of the target motor rotational angle θ* utilizing the control-use lateral acceleration Gy* as a parameter. The target motor rotational angle θ* is determined referring to the map data. FIG. 7 schematically shows the map data. Where the control-use lateral acceleration Gy* is positive, the vehicle is turning to the left. Where the control-use lateral acceleration Gy* is negative, the vehicle is turning to the right. Upon the left turning of the vehicle, the target motor rotational angle θ* is determined, to restrain the roll of the vehicle, such that each stabilizer apparatus 14 generates the stabilizer force in a direction in which the vehicle body and the left wheel that is located on the inner side with respect to the turning are moved toward each other and also generates the stabilizer force in a direction in which the vehicle body and the right wheel that is located on the outer side with respect to the turning are moved away from each other. On the other hand, upon the right turning of the vehicle, the target motor rotational angle θ* is determined, to restrain the roll of the vehicle, such that each stabilizer apparatus 14 generates the stabilizer force in a direction in which the vehicle body and the right wheel that is located on the inner side with respect to the turning are moved toward each other and also generates the stabilizer force in a direction in which the vehicle body and the left wheel that is located on the outer side with respect to the turning are moved away from each other.

Subsequently, the electromagnetic motor 130 is controlled such that the actual motor rotational angle θ coincides with the target motor rotational angle θ* determined as described above. In the control of the electromagnetic motor 130, the electric power to be supplied to the same 130 is determined based on motor-rotational-angle deviation Δθ (=θ*−θ) which is deviation of the actual motor rotational angle θ with respect to the target motor rotational angle θ*. More specifically explained, the electric power to be supplied to the electromagnetic motor 130 is determined according to a feedback control technique based on the motor-rotational-angle deviation Δθ. Initially, the motor-rotational-angle deviation Δθ is identified based on the value detected by the motor-rotational-angle sensor 146 of the electromagnetic motor 130. Subsequently, the target supply current i* is determined utilizing the motor-rotational-angle deviation Δθ as a parameter, according to the following formula:

i*=K_{P}·Δθ+K_{I}·Int(Δθ)

The above-indicated formula is according to a PI control rule. The first term and the second term in the formula respectively mean a proportional-term component and an integral-term component, and “K_{P}”, “K_{I}” are a proportional gain and an integral gain, respectively. Further, “Int(Δθ)” corresponds to an integral value of the motor-rotational-angle deviation Δθ.

The target supply current i* indicates the direction of generation of the motor force of the electromagnetic motor 130 depending upon its sign (+, −). When the electromagnetic motor 130 is controlled by being driven, the duty ratio and the direction of generation of the motor force for driving the motor 130 are determined on the basis of the target supply current i*. Commands indicative of the determined duty ratio and direction of generation of the motor force are sent to the corresponding inverter 174, whereby the electromagnetic motor 130 is controlled by the inverter 174 based on the commands.

In the present embodiment, the target supply current i* is determined according to the PI control rule. The target supply current i* may be determined according to a PDI control rule. In this instance, the target supply current i* may be determined according to the following formula, for instance:

i*=K_{P}·Δθ+K_{I}·Int(Δθ)+K_{D}·Δθ′

wherein “K_{D}” is a differential gain, and the third term means a differential-term component.

### 2.2. Control of Damping Coefficient of Absorber

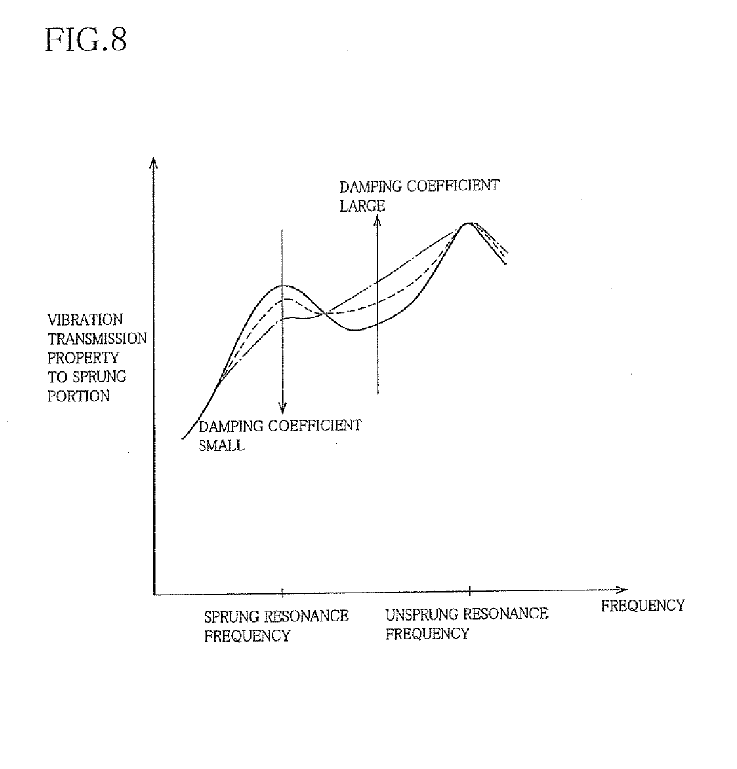

Each absorber 52 is configured to generate, with respect to the relative movement of the sprung portion and the unsprung portion, a damping force whose magnitude corresponds to the speed of the relative movement of the sprung portion and the unsprung portion. The absorber 52 generates the damping force having the magnitude based on the damping coefficient set for the absorber 52. Accordingly, the damping coefficient indicates an ability of the absorber to generate the damping force. In the meantime, the value of the damping coefficient affects transmission property of a vibration from the unsprung portion to the sprung portion. More specifically described with reference to FIG. 8, the transmission property of a vibration in the sprung resonance frequency range decreases with an increase in the damping coefficient whereas the transmission property of a vibration in the unsprung resonance frequency range increases with an increase in the damping coefficient. Accordingly, where the damping coefficient of the absorber is high during running of the vehicle on a bad road at which the vibration in the unsprung resonance frequency range tends to generate, there may be a risk of deterioration in the ride comfort as felt by vehicle passengers.

Each absorber 52 of the present suspension system 10 is configured to change the damping coefficient between the two values as explained above. As the damping coefficient of the absorber 52, the two values are set one of which is the first damping coefficient C₁ as a standard damping coefficient and the other of which is the second damping coefficient C₂ that is smaller than the first damping coefficient C₁. The damping coefficient of the absorber 52 is changed by the control so as to be selected from the two damping coefficients C₁, C₂.

Where the damping coefficient of the absorber 52 to be established by the control is defined as a target damping coefficient C*, the target damping coefficient C* is generally made equal to the first damping coefficient C₁. When the vibration in the unsprung resonance frequency range is generated, however, the target damping coefficient C* is made equal to the second damping coefficient C₂. That is, in the present system 10, a damping-coefficient reduction control for reducing the damping coefficient of the absorber 52 is executed when a prescribed bad-road running condition based on which the vehicle is judged to be running on a bad road is satisfied.

For judging whether a vibration inputted from the wheel to the vehicle body is the vibration in the unsprung resonance frequency range, a vibration component in the frequency range is calculated by filtering, and the magnitude of the vibration component in the frequency range is subjected to comparison. More specifically explained, the sprung vertical acceleration Gs is initially detected by the sprung-vertical-acceleration-sensor 196, and the filtering is carried out for the vibration in a range of ±3 Hz from the unsprung resonance frequency, on the basis of the detected vertical acceleration Gs. Thereafter, there is calculated an amplitude a which is the intensity of the vibration in the unsprung resonance frequency range. Where the calculated amplitude α is not smaller than a threshold α₁, it is judged that the vehicle is running on the bad road, and the target damping coefficient C* is made equal to the second damping coefficient C₂. That is, under the bad-road running condition as the prescribed condition, it is judged that the vehicle is running on the bad road based on the magnitude of the component of the vibration in the specific frequency range among vibrations inputted from the wheel to the vehicle body.

### 2.3. Control of Stabilizer Apparatus in Damping-Coefficient Reduction Control

The force generated by each absorber 52, i.e., the absorber force, acts as a resistance force with respect the relative movement of the sprung portion and the unsprung portion. Accordingly, in some cases, the roll of the vehicle body due to turning of the vehicle is influenced by the absorber force. When the roll moment that the vehicle body undergoes changes, the absorber force acts as a resistance force with respect to the roll of the vehicle body. In particular when the roll moment increases in an initial period of turning of the vehicle, the absorber force acts as the resistance force with respect to an increase in the roll of the vehicle body, thereby suppressing an increase in the roll amount of the vehicle body.

In the present system 10, the damping coefficient of the absorber 52 is changed from the first damping coefficient C₁ to the second damping coefficient C₂ that is smaller than the first damping coefficient C₁, upon the damping-coefficient reduction control. Accordingly, the absorber force when the damping-coefficient reduction control is under execution is smaller than that when the damping-coefficient reduction control is not under execution. Accordingly, there may be a risk that the effect of restraining the roll of the vehicle body becomes lower when the damping coefficient of the absorber is set at the second damping coefficient C₂ than when the damping coefficient of the absorber is set at the first damping coefficient C₁.

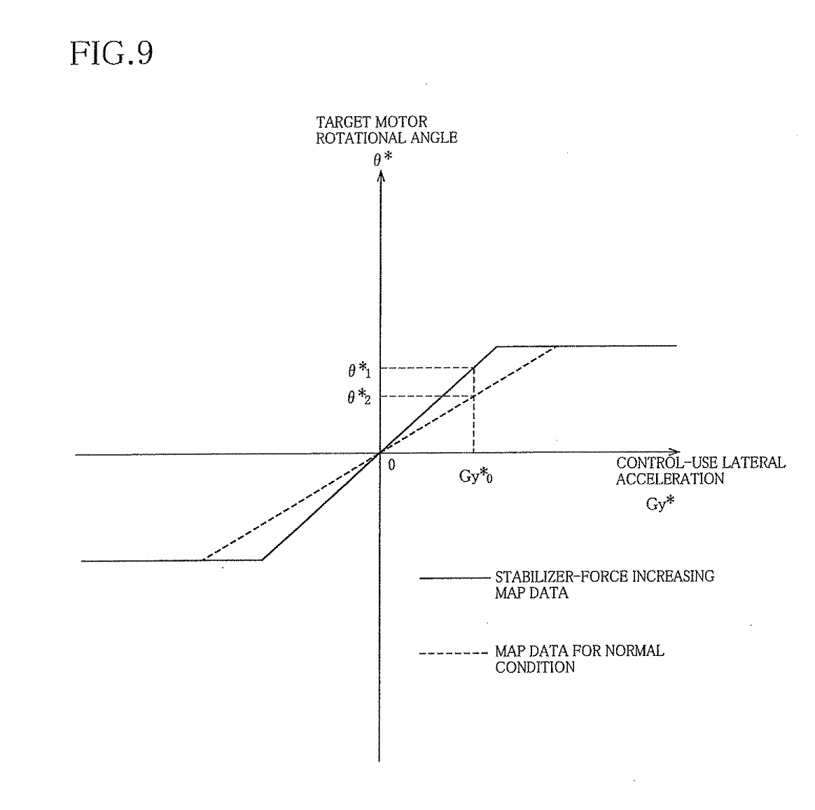

In view of the above, the present system 10 is arranged such that the stabilizer force is increased in an instance where the damping-coefficient reduction control is under execution, as compared with an instance where the damping-coefficient reduction control is not under execution, in order to increase the force that acts on the sprung portion and the unsprung portion as the roll restraining force, where the damping coefficient of the absorber 52 is set at the second damping coefficient C₂, namely, where the damping-coefficient reduction control is under execution. More specifically explained, when the damping coefficient of the absorber 52 is set at the second damping coefficient C₂, the map data set as indicated by the solid line in FIG. 9 is referred to for determining the target motor rotational angle θ* based on the control-use lateral acceleration Gy*. This map data is set so as to increase the target motor rotational angle θ* for increasing the stabilizer force and functions as stabilizer-force increasing map data. As apparent from FIG. 9, for the same degree of the control-use lateral acceleration Gy*₀, the target motor rotational angle θ*₁ determined by referring to the map data indicated by the solid line in FIG. 9 is larger than the target motor rotational angle θ*₂ determined by referring to map data indicated by the dotted line in FIG. 9, namely, map data for a normal condition. Thus, in the present system 10, the target motor rotational angle θ* is increased and the stabilizer force is thereby increased when the damping-coefficient reduction control is executed, so that the roll restraining effect is prevented from being deteriorated due to the reduction in the absorber coefficient of the absorber 52. It is noted that the map data is prohibited from being changed between the above-indicated two sorts of map data during turning of the vehicle for preventing an abrupt change in the posture of the vehicle body due to an abrupt change in the stabilizer force.

### 3. Control Programs

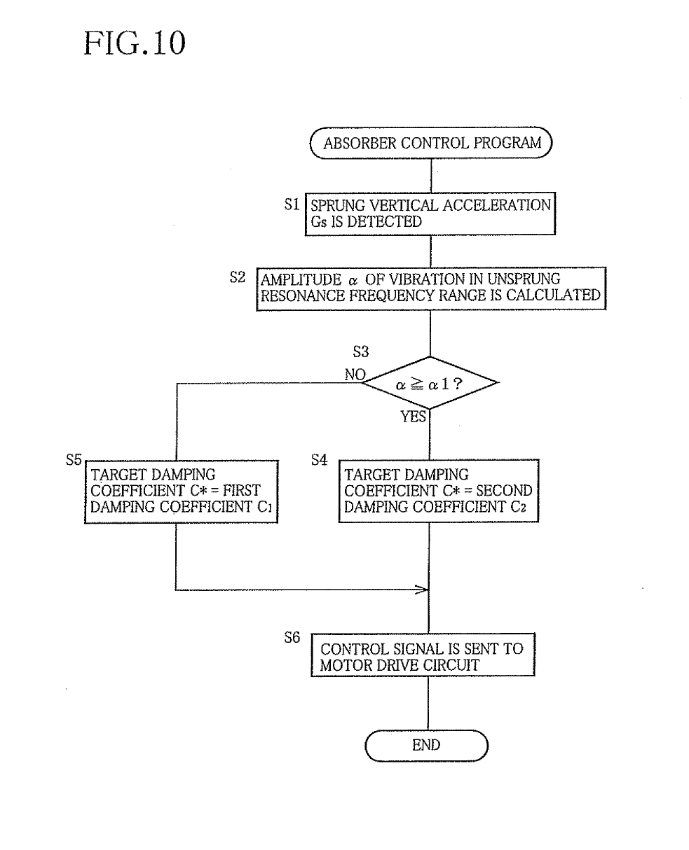

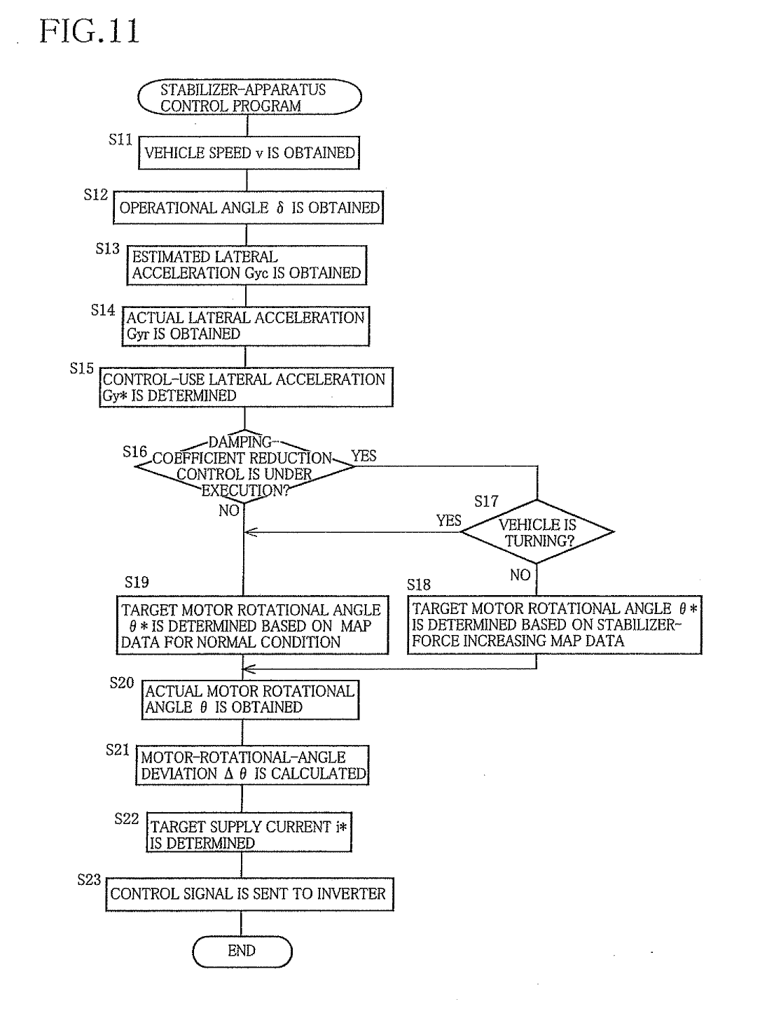

In the present system 10, the control of the damping coefficient of the absorber 52 is executed such that an absorber control program indicated by a flow chart of FIG. 10 is implemented by the absorber controller 180. The control of the stabilizer force generated by the stabilizer apparatus 14 is executed such that a stabilizer-apparatus control program indicated by a flow chart of FIG. 11 is implemented by the stabilizer-apparatus controller 176. These two programs are repeatedly implemented at short intervals (e.g., several milliseconds) with an ignition switch placed in an ON state and are implemented in parallel with each other. The flow of each control will be briefly explained referring to the corresponding flow chart. The absorber control program is implemented for each of the four absorbers 52 while the stabilizer-apparatus control program is implemented for each of the actuators 26 of the respective two stabilizer apparatuses 14. In the following description, there will be explained control processing for one absorber 52 and control processing for one actuator 26, in the interest of brevity.

### 3.1. Absorber Control Program

In the processing according to the absorber control program, step S1 (“step” is omitted where appropriate) is initially implemented to detect the sprung vertical acceleration Gs by the sprung-vertical-acceleration sensor 196. Next, it is judged whether the above-described bad-road running condition is satisfied. More specifically, in S2, the filtering for the unsprung resonance frequency range is carried out on the basis of the detected sprung vertical acceleration Gs, so as to calculate the amplitude a of the vibration in the unsprung resonance frequency range. Subsequently, it is judged in S3 whether the calculated amplitude α is not smaller than the threshold α₁. Where the amplitude α is not smaller than the threshold α₁, it is judged that the vibration in the unsprung resonance frequency range is being generated, namely, it is judged that the vehicle is running on the bad road, and S4 is implemented to set the target damping coefficient C* at the second damping coefficient C₂. On the other hand, where it is judged in S3 that the calculated amplitude α is smaller than the threshold α₁, it is judged that the vehicle is not running on the bad road, and S5 is implemented to set the target damping coefficient C* at the first damping coefficient C₁. The control flow then goes to S6 in which a control signal based on the determined target damping coefficient C* is sent to the motor drive circuit 178. Thus, one execution of the absorber control program is ended.

### 3.2. Stabilizer-Apparatus Control Program

In the processing according to the stabilizer-apparatus control program, step S11 is initially implemented to obtain the vehicle speed v based on the calculated value of the brake ECU 200. Next, in 512, the operation angle δ of the steering wheel is obtained based on the value detected by the steering sensor 190. S12 is followed by S13 in which the estimated lateral acceleration Gyc is obtained on the basis of the obtained vehicle speed v and operation angle δ. In the stabilizer-apparatus controller 176, there are stored map data relating to estimated lateral acceleration Gyc. The map data utilizes vehicle speed v and operational angle δ as parameters. The estimated lateral acceleration Gyc is obtained by referring to the map data. Subsequently, S14 is implemented to obtain the actual lateral acceleration Gyr that is lateral acceleration actually generated in the vehicle body, on the basis of the value detected by the lateral-acceleration sensor 192. S14 is followed by S15 in which the control-use lateral acceleration Gy* is determined on the basis of the estimated lateral acceleration Gyc and the actual lateral acceleration Gyr as explained above.

Subsequently, S16 is implemented to judge whether the damping-coefficient reduction control is under execution. More specifically explained, it is judged whether the target damping coefficient C* for any of the absorbers 52 determined in the above-described absorber control program is equal to the second damping coefficient C₂. The stabilizer-apparatus controller 176 obtains, from the absorber controller 180, information as to the target clamping coefficient C* of the absorber 52, as needed. Where it is judged that the target damping coefficient C* is set at the second damping coefficient C₂, namely, where it is judged that the damping-coefficient reduction control is under execution, S17 is implemented to judge whether the vehicle is turning. More specifically, it is judged whether previous target motor rotational angle θ*_{P} that has been determined in previous execution of the program is larger than a threshold β. Where it is judged that the previous target motor rotational angle θ*_{P} is not larger than the threshold B, namely, it is judged that the vehicle is not turning, S18 is implemented to determine the target motor rotational angle θ* based on the control-use lateral acceleration Gy* by referring to the stabilizer-force increasing map data shown in FIG. 9. On the other hand, where it is judged in S16 that the damping-coefficient reduction control is not under execution or where it is judged in S17 that the vehicle is turning, S19 is implemented to determine the target motor rotational angle θ* based on the control-use lateral acceleration Gy* by referring to the map data for the normal condition shown in FIG. 9.

After the target motor rotational angle θ* has been determined, S20 is implemented to obtain the actual motor rotational angle θ by the motor-rotational-angle sensor 146. Subsequently, S21 is implemented to determine the motor-rotational-angle deviation Δθ that is deviation of the actual motor rotational angle θ with respect to the target motor rotational angle θ*. Thereafter, S22 is implemented to determine the target supply current i* based on the target motor rotational angle θ* according to the above-indicated PI control rule, and subsequently S23 is implemented to send, to the inverter 174, a control signal based on the determined target supply current i*. Thus, one execution of the program is ended.

### 4. Functional Structure of Controller

The absorber controller 180 that executes the above-described absorber control program may be considered to have the functional structure shown in FIG. 12, in view of the processing executed by the absorber controller 180. As apparent from FIG. 12, the absorber controller 180 includes: a damping-coefficient control portion 220 as a functional portion to execute the processing in S4-S6, namely, as a functional portion to control the damping coefficient of the absorber 52; and a bad-road-running judging portion 222 as a functional portion to execute the processing in S1-S3, namely, as a functional portion to judge whether the vehicle is running on the bad road. The damping-coefficient control portion 220 includes a damping-coefficient-reduction-control executing portion 224 as a functional portion to execute the processing in S4 and S6, namely, as a functional portion to execute the damping-coefficient reduction control.

The stabilizer-apparatus controller 176 that executes the above-described stabilizer-apparatus control program may be considered to have the functional structure shown in FIG. 12 in view of the processing executed by the stabilizer-apparatus controller 180. As apparent from FIG. 12, the stabilizer-apparatus controller 176 includes: a control-use-lateral-acceleration determining portion 226 as a functional portion to execute the processing in S11-S15, namely, as a functional portion to determine the control-use lateral acceleration Gy* as a roll-moment index amount; and a stabilizer-force control portion 228 as a functional portion to execute the processing in S16-S23, namely, as a functional portion to control the stabilizer force. The stabilizer-force control portion 228 includes a stabilizer-force increasing portion 220 as a functional portion to execute the processing in S16-S18, namely, as a functional portion to increase the stabilizer force.

### 5. Modified Embodiment

While the absorber 52 in the present suspension system 10 is configured to change the damping coefficient in two steps, it is possible to employ an absorber configured to change the damping coefficient in more steps, e.g., in seven steps. As the damping coefficient in the thus configured absorber, there may be set seven damping coefficients, i.e., a standard damping coefficient C_{M}, three high damping coefficients G_{H} which are larger than the standard clamping coefficient C_{M}, and three low damping coefficients C_{L} which are smaller than the standard damping absorber coefficient C_{M}. The damping coefficient of the absorber is changeable by a control, so as to be selected from among the seven damping coefficients.

For instance, the damping coefficient may be changed depending upon the vehicle speed. More specifically, the damping coefficient may be made larger with an increase in the vehicle speed in a high speed range for giving precedence to maneuverability of the vehicle while the damping coefficient may be made smaller with a decrease in the vehicle speed in a low speed range for giving precedence to the ride comfort of the vehicle. Further, the damping coefficient may be changed depending upon the road surface on which the vehicle travels. In more detail, when the vehicle travels on a mogul road, the vehicle body tends to be jolted, resulting in a deterioration of the stability of the vehicle body. In view of this, the damping coefficient may be controlled such that the damping coefficient of the absorber initially set at a high level is changed into a low level when the vehicle travels on the bad rod, for avoiding the deterioration in the ride comfort.

In the control of the damping coefficient of the absorber described above, there may be a risk that the absorber force becomes smaller in an instance where the damping coefficient is set at one of the low damping coefficients C_{L} smaller than the standard damping coefficient C_{M}, namely, in an instance where the damping-coefficient reduction control is under execution, as compared with an instance where the damping-coefficient reduction control is not under execution. In this case, the roll restraining effect may be undesirably deteriorated. Accordingly, the stabilizer force is increased during execution of the damping-coefficient reduction control also in the system having the absorber configured as describe above. Here, the low damping coefficients C_{L} are set in three steps, i.e., a first low damping coefficient C_{L1} smaller than the standard damping coefficient C_{M}, a second low damping coefficient C_{L2} smaller than the first low damping coefficient C_{L1}, and a third low damping coefficient C_{L3} smaller than the second low damping coefficient C_{L2} (C_{M}>C_{L1}>C_{L2}>C_{L3}). Accordingly, there are prepared three sorts of map data for increasing the stabilizer force.

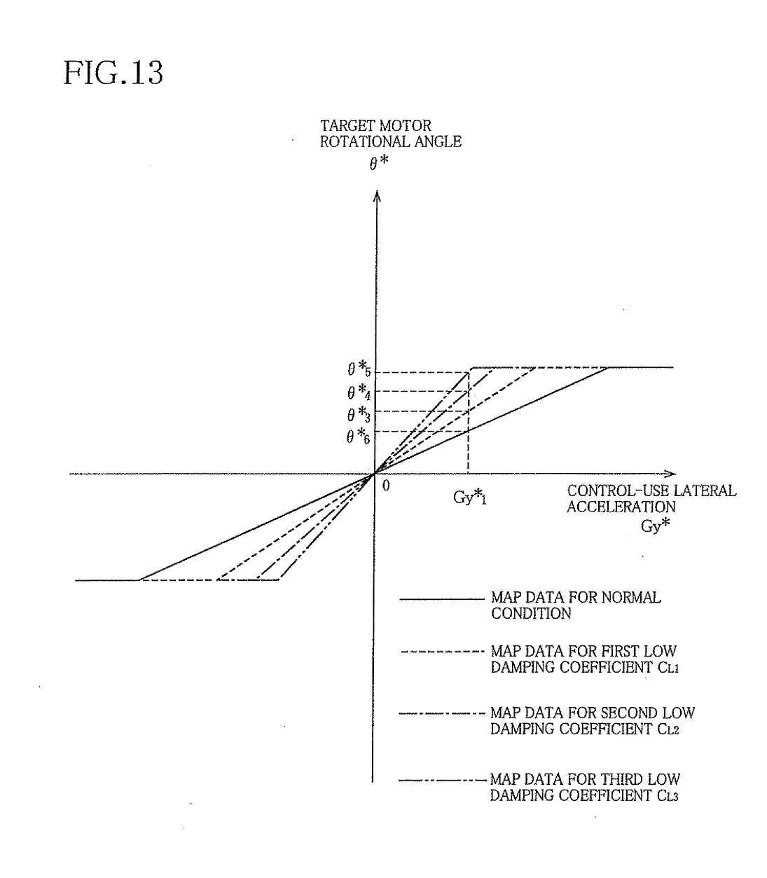

More specifically explained, when the damping coefficient of the absorber is set at the first low damping coefficient C_{L1} in determining the target motor rotational angle θ* on the basis of the control-use lateral acceleration Gy*, the map data indicated by the dotted line in FIG. 13 is referred to. Similarly, when the damping coefficient of the absorber is set at the second low damping coefficient C_{L2}, the map data indicated by the one-dot chain line in FIG. 13 is referred to. Further, when the damping coefficient of the absorber is set at the third low damping coefficient C_{L3}, the map data indicated by the two-dot chain line in FIG. 13 is referred to. As apparent from FIG. 13, for the same degree of the control-use lateral acceleration Gy*₁, the target motor rotational angles θ*₃, θ*₄, θ*₅ determined during execution of the damping-coefficient reduction control are larger than the target motor rotational angle θ*₆ determined referring to the map data for a normal condition indicated by the solid line in FIG. 13. Further, these target motor rotational angles θ*₃, θ*₄, θ*₅ during the damping-coefficient reduction control are determined depending upon a degree of reduction in the damping coefficient (θ*₅>θ*₄>θ*₃>θ*₆). Thus, the stabilizer force is increased depending upon the degree of reduction in the damping coefficient, whereby the roll restraining effect is prevented from being lowered due to the reduction in the damping coefficient even when the damping coefficient is reduced in a plurality of steps.

While the stabilizer force is increased by increasing the target motor rotational angle θ* in the present system 10, the stabilizer force may be increased by increasing the control-use lateral acceleration Gy* or the like. Alternatively, the stabilizer force may be increased by increasing the target supply current i*.

1. A suspension system for a vehicle, comprising:
a stabilizer apparatus which includes an actuator and a stabilizer bar whose opposite ends are connected to left and right wheels of the vehicle, respectively, and which generates a stabilizer force that is based on a twist-reacting force of the stabilizer bar, the stabilizer force being changeable by the actuator;
a pair of absorbers of a hydraulic type each of which is provided for a corresponding one of the left and right wheels, each of which generates a damping force with respect to a relative movement of the corresponding one of the left and right wheels and a body of the vehicle, and which respectively include damping-coefficient changing mechanisms each configured to change a damping coefficient that is an ability to generate the damping force and that is a basis of a magnitude of the damping force to be generated; and
a control device which includes: a stabilizer-force control portion configured to control the stabilizer force generated by the stabilizer apparatus, by controlling the actuator in accordance with roll moment acting on the body of the vehicle due to turning of the vehicle; and a damping-coefficient control portion configured to control the damping coefficient of each of the pair of absorbers by controlling a corresponding one of the damping-coefficient changing mechanisms,
wherein the damping-coefficient control portion is configured to execute a damping-coefficient reduction control for reducing the damping coefficient of said each of the pair of absorbers when a prescribed condition is satisfied, and
wherein the stabilizer-force control portion is configured to increase the stabilizer force generated by the stabilizer apparatus in an instance where the damping-coefficient reduction control is under execution, as compared with an instance where the damping-coefficient reduction control is not under execution.

2. The suspension system according to claim 1, wherein the damping-coefficient reduction control is executed when a prescribed bad-road running condition in which the vehicle is supposed to be running on a bad road is satisfied, the prescribed bad-road running condition being defined as the prescribed condition.

3. The suspension system according to claim 2, wherein the prescribed bad-road running condition is defined as a condition that an intensity of a vibration in a specific frequency range among vibrations inputted to the body from the wheel exceeds a threshold.

4. The suspension system according to any one of claims 1-3,
wherein the stabilizer bar is constituted by a pair of stabilizer bar members each of which includes a torsion bar portion disposed so as to extend in a width direction of the vehicle and an arm portion which extends continuously from the torsion bar portion so as to intersect the torsion bar portion and which is connected at a leading end portion thereof to a wheel-holding portion that holds a corresponding one of the left and right wheels, and
wherein the actuator is configured to rotate the torsion bar portions of the pair of stabilizer bar members relative to each other.

5. The suspension system according to claim 4, wherein the actuator includes an electromagnetic motor as a drive source, a decelerator which decelerates rotation of the electromagnetic motor, and a housing which holds the electromagnetic motor and the decelerator, and
wherein the torsion bar portion of one of the pair of stabilizer bar members is connected to the housing so as to be unrotatable relative to the housing while the torsion bar portion of the other of the pair of stabilizer bar members is connected to an output portion of the decelerator so as to be unrotatable relative to the output portion.
